(19) United States
(12) Patent Application Publication
(10) Pub. No.: US 2014/0318826 A1
(43) Pub. Date: Oct. 30, 2014

(54) Visual Current Power Line

(71) Applicant: Xiangxuan CAI, DONGGUAN CITY (CN)

(72) Inventor: Xiangxuan CAI, DONGGUAN CITY (CN)

(21) Appl. No.: 13/872,153

(22) Filed: Apr. 28, 2013

(51) Int. Cl. H01B 7/02

(52) U.S. Cl. CPC H01B 7/0291
USPC 174/112

(57) ABSTRACT

A visual current power line, which contains one or more flexible center electrodes that are sheathed by a luminous layer and a light-pervious conducting layer sequentially. The outer of each center electrode is coated with an insulating layer, i.e. a polyurethane coating containing polyisocyanate. The center electrodes, jacketed with an insulating bush, are round wires with an outer diameter of 0.205-0.25 mm. The luminous layer locates on the outer of the insulating bush, and the light-pervious conducting layer is covered by a transparent plastic layer, outside of which there is a color-changing plastic layer. Powder particles in the luminous layer are wrapped up by transparent, insulating, and dielectric thermoplastic polymer. The invention of current power line has features of good insulation, long life, low processing cost, reliable quality, large luminous area, and can be widely used in analogy, decoration, advertising, handicraft weaving and other fields of power or data lines.

### BACKGROUND OF THE INVENTION

The invention belongs to cable product, specifically relating to a kind of power line with luminous display.

Existing power lines cannot display whether they are plugged in or whether they are at working. In other words, by seeing from the outer surface of these power lines, we do not know whether they are at the working status of data transmitting or power charging. However, luminous core wire can be a good solution to this problem. The luminous core wire is made of a metal baseline, whose outer is wrapped or coated with an insulating dielectric layer, a luminous powder layer and a transparent conductive layer sequentially. When such luminous core wire is powdered on, it will luminesce to show its working status, adding dynamic new features to ordinary power lines.

Applied on Aug. 19, 2005 and proclaimed for authorization on Jan. 19, 2011, the patent Piecewise-luminous Electroluminescent Cable, which obtains a patent No. 200510019319.X, discloses a visual current power line. The insulating medium on its metal baseline is a mixture of titanium dioxide and polyurethane, whose stickiness and insulation are too poor to achieve a satisfied aesthetics when it is used as the charging line of iphone4, HTC, Samsung mobile phone or other up-to-date electronic devices. The metal baseline is made of round wire with a diameter of 0.03-0.20 mm, which is too small that the power line is of low hardness and short life. There are two auxiliary electrodes intertwining on the outer of the luminous core wire, and it requires a high processing cost to make such intertwining. When the power line's outermost layer, namely the transparent plastic layer, is taken off for welding, the internal conductive layer will be completely exposed and may get in touch with other wires, resulting in an unstable quality and influencing the effect of electrical connection.

### BRIEF SUMMARY OF THE INVENTION

The invention aims to provide a visual current supply line with effective insulation, long life, low processing cost and reliable quality.

In order to solve the technical problems, the invention employs the following technical solution: a visual current power line, which contains one or more flexible center electrodes that are sheathed by a luminous layer and a light-pervious conducting layer sequentially; the outer of each center electrode is coated with an insulating layer, i.e. a polyurethane coating containing polyisocyanate; the center electrodes, jacketed with an insulating bush, are round wires with an outer diameter of 0.205-0.25 mm; the luminous layer locates on the outer of the insulating bush, and the light-pervious conducting layer is covered by a transparent plastic layer, outside of which there is a color-changing plastic layer; powder particles in the luminous layer are wrapped up by transparent, insulating, and dielectric thermoplastic polymer.

Furthermore, the color-changing plastic layer is PVC.

Moreover, the light-pervious conducting layer is equipped with one or more auxiliary electrodes in the transparent plastic layer, and the auxiliary electrodes are placed on the two sides of the outer of the light-pervious conducting layer.

Besides, the thermoplastic polymer consists of polyvinyl chloride, polyethylene terephthalic acid, polypropylene, polystyrene, polycarbonate and polysulphone. The luminous powder particles are copper powder doped with zinc sulfide or organics of polyphenyl acetylene, poly-alkyl thiophene or poly-alkyl fluorene.

What's more, the center electrodes are made of single non-metallic conductive wire, or multiple non-metallic conductive wires glued by conductive adhesive, or a metal/non-metallic conductive layer, or a net layer.

In addition, the visual current power line is printed with words or patterns.

Beneficial effects of the invention: the outer of each center electrode is coated with an insulating layer, i.e. a polyurethane coating containing polyisocyanate, which is of good stickiness, effective insulation and strong stretch resistance, realizing a better spotlight effect when the visual current power line is used as the data or mouse cables of iphone4, HTC, Samsung mobile phone or other up-to-date digital products; The increase of center electrodes' outer diameter greatly enhance the hardness, wear resistance and service life of the visual current power line; the auxiliary electrodes outside the light-pervious conductive layer no longer intertwine with each other, but locate in a parallel way on the light-pervious conductive layer, which can tremendously reduce the processing cost, and thus can achieve a substantial decline in the production cost of the power line to improve its product competitiveness greatly; the transparent plastic layer has a color-changing layer, and when it needs to have a taken-off welding, it is the transparent plastic layer that is exposed while the conductive layer is still coated, avoiding the unstable quality caused by the touching of wires.

### BRIEF DESCRIPTION OF THE DRAWINGS

FIG. 1 is the sectional view for an embodiment of the invention;

FIG. 2 is the sectional view for another embodiment of the invention.

### DETAILED DESCRIPTION OF THE INVENTION

The invention will be further described in detail with the help of attached drawings and embodiments as follow.

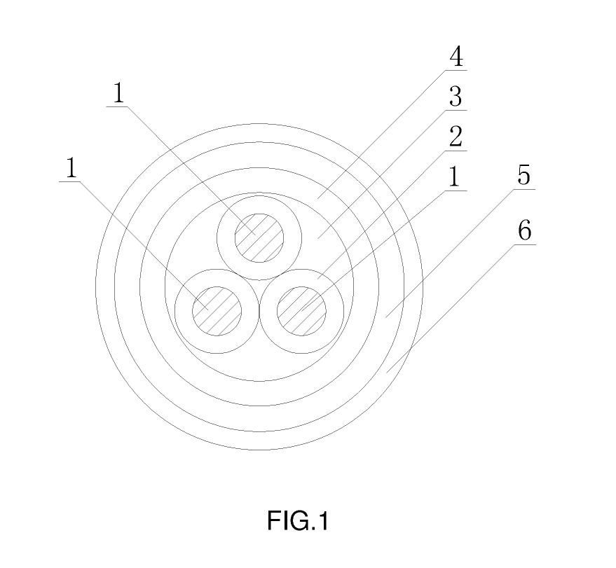

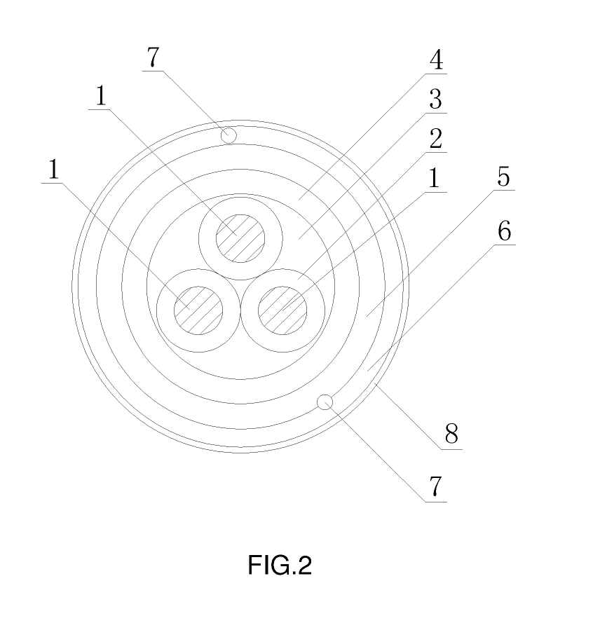

As shown in FIGS. 1 and 2, the invention discloses a visual current power line, which contains one or more flexible center electrodes (1) that are sheathed by a luminous layer (4) and a light-pervious conducting layer (5) sequentially. The outer of each center electrode (1) is coated with an insulating layer (2), i.e. a polyurethane coating containing polyisocyanate. The center electrodes (1), jacketed with an insulating bush (3), are round wires with an outer diameter of 0.205-0.25 mm. The luminous layer (4) locates on the outer of the insulating bush (3), and the light-pervious conducting layer (5) is covered by a transparent plastic layer (6) printed with words and patterns. Outside of the transparent plastic layer (6), there is a color-changing plastic layer (8). Powder particles in the luminous layer (4) are wrapped up by transparent, insulating, and dielectric thermoplastic polymer. The color-changing plastic layer (8) is PVC. The light-pervious conducting layer (5) is equipped with one or more auxiliary electrodes (7) in the transparent plastic layer (6), and the auxiliary electrodes (7) are placed on the two sides of the outer of the light-pervious conducting layer (5). The outer of each center electrode (1) in the invention is coated with an insulating layer, i.e. a polyurethane coating containing polyisocyanate, which is of good stickiness, effective insulation and strong stretch resistance, realizing a better spotlight effect when the visual current power line is used as the data or mouse cables of iphone4, HTC, Samsung mobile phone or other up-to-date digital products; The increase of center electrodes' (1) outer diameter greatly enhance the hardness, wear resistance and service life of the visual current power line; the auxiliary electrodes (7) outside the light-pervious conductive layer (5) no longer intertwine with each other, but locate in a parallel way on the light-pervious conductive layer (5), which can tremendously reduce the processing cost, and thus can achieve a substantial decline in the production cost of the power line to improve its product competitiveness greatly; the transparent plastic layer (6) has a color-changing layer (8), and when it needs to have a taken-off welding, it is the transparent plastic layer (6) that is exposed while the conductive layer (5) is still coated, avoiding the unstable quality caused by the touching of wires.

Furthermore, the thermoplastic polymer consists of polyvinyl chloride, polyethylene terephthalic acid, polypropylene, polystyrene, polycarbonate and polysulphone. The luminous powder particles are copper powder doped with zinc sulfide or organics of polyphenyl acetylene, poly-alkyl thiophene or poly-alkyl fluorene. Thanks to the insulating layer coated on each center electrode and the insulating bush jacked on one or more center electrodes, the insulating property of the visual current power line is highly improved. The visual current supply line can be printed with words or patterns, such as I LOVE YOU, company logo and so on, which will luminesce one by one when it is powered on. To meet the consumer demand for personalized custom, the words or patterns can be printed on the outermost layer, the penultimate layer, the antepenultimate layer or any layer of the power line. The power line of the invention is of softness, lightness, strong stretch resistance and large luminous area. It is thus suitable for continuous industrial production, and can be widely used in analogy, decoration, advertising, handicraft weaving and other fields of power or data lines.

The foregoing embodiments are merely exemplary description of the principles and effects of the invention, and part of the used embodiment may be made some changed and improved to some extend by ordinary technical staff in the field without departing from the premise of the invention's creative ideas. These belong to the scope of protection of the invention.

What is claimed is:

1. A visual current power line, which contains one or more flexible center electrodes (1) that are sheathed by a luminous layer (4) and a light-pervious conducting layer (5) sequentially. Its features: the outer of each center electrode (1) is coated with an insulating layer (2), i.e. a polyurethane coating containing polyisocyanate. The center electrodes (1), jacketed with an insulating bush (3), are round wires with an outer diameter of 0.205-0.25 mm. The luminous layer (4) locates on the outer of the insulating bush (3), and the light-pervious conducting layer (5) is covered by a transparent plastic layer (6), outside of which there is a color-changing plastic layer (8). Powder particles in the luminous layer (4) are wrapped up by transparent, insulating, and dielectric thermoplastic polymer.

2. The visual current power line as claimed in claim 1 features that the color-changing plastic layer (8) is PVC.

3. The visual current power line as claimed in claim 2 features that the light-pervious conducting layer (5) is equipped with one or more auxiliary electrodes (7) in the transparent plastic layer (6), and that the auxiliary electrodes (7) are placed on the two sides of the outer of the light-pervious conducting layer (5).

4. The visual current power line as claimed in claim 3 features that the thermoplastic polymer consists of polyvinyl chloride, polyethylene terephthalic acid, polypropylene, polystyrene, polycarbonate and polysulphone.

5. The visual current power line as claimed in claim 4 features that the luminous powder particles are copper powder doped with zinc sulfide or organics of polyphenyl acetylene, poly-alkyl thiophene or poly-alkyl fluorene.

6. The visual current power line as claimed in claim 5 features that the center electrodes (1) are made of single non-metallic conductive wire, or multiple non-metallic conductive wires glued by conductive adhesive, or a metal/non-metallic conductive layer, or a net layer.
